(19) United States
(12) Patent Application Publication
(10) Pub. No.: US 2006/0280860 A1
(43) Pub. Date: Dec. 14, 2006

(54) Cobalt electroless plating in microelectronic devices

(75) Inventors: Vincent Paneccasio JR., Madison, CT (US); Qingyun Chen, Branford, CT (US); Charles Valverde, Ansonia, CT (US); Nicolai Petrov, Hamden, CT (US); Christian Witt, Woodbridge, CT (US); Richard Hurtubise, Clinton, CT (US)

Correspondence Address: SENNIGER POWERS, ONE METROPOLITAN SQUARE, 16TH FLOOR, ST LOUIS, MO, 63102, US

(73) Assignee: Enthone Inc., West Haven, CT (US)

(21) Appl. No.: 11/148,724

(22) Filed: Jun. 9, 2005

(51) Int. Cl. B05D 5/12; C23C 18/34; C23C 18/36

(52) U.S. Cl. 427/99.5; 106/1.22; 106/1.27

(57) ABSTRACT

An electroless plating method and composition for depositing Co or Co alloys onto a metal-based substrate in manufacture of microelectronic devices, involving a source of Co ions, a reducing agent for reducing the depositions ions to metal onto the substrate, and an oxime-based compound stabilizer.

### FIELD OF THE INVENTION

This invention relates to electroless plating of Co and Co alloys in microelectronic device applications.

### BACKGROUND OF THE INVENTION

Electroless deposition of Co is performed in a variety of applications in the manufacture of microelectronic devices. For example, Co is used in capping of damascene Cu metallization employed to form electrical interconnects in integrated circuit substrates. Copper can diffuse rapidly into a Si substrate and dielectric films such as, for example, SiO₂ or low k dielectrics. Copper can also diffuse into a device layer built on top of a substrate in multilayer device applications. Such diffusion can be detrimental to the device because it can cause electrical leakage in substrates, or form an unintended electrical connection between two interconnects resulting in an electrical short. Moreover, Cu diffusion out of an interconnect feature can disrupt electrical flow. Copper also has a tendency to migrate out of interconnect features when electrical current passes through features in service. This migration can damage an adjacent interconnect line, cause junction leakage, form unintended electrical connections, and disrupt electrical flow in the feature from which the metal migrates. Cobalt capping is employed to inhibit this Cu diffusion and migration.

Accordingly, among the challenges facing integrated circuit device manufacturers is to minimize diffusion and electromigration of metal out of metal-filled interconnect features. This challenge becomes more acute as the devices further miniaturize, and as the features further miniaturize and densify.

Another challenge in the context of metal interconnect features is to protect them from corrosion. Certain interconnect metals, especially Cu, are more susceptible to corrosion. Copper is a fairly reactive metal which readily oxidizes under ambient conditions. This reactivity can undermine adhesion to dielectrics and thin films, resulting in voids and delamination. Another challenge is therefore to combat oxidation and enhance adhesion between the cap and the Cu, and between structure layers.

The industry has deposited Co-based caps over Cu and other metal interconnect features, as discussed in, for example, U.S. patent publication number 2003/0207560 and U.S. patent application Ser. No. 10/867,346.

A particular Co-based metal capping layer employed to reduce Cu migration, provide corrosion protection, and enhance adhesion between the dielectric and Cu is a ternary alloy including Co, W, and P. Another refractory metal may replace or be used in addition to W, and B is often substituted for or used in addition to P. Each component of the ternary alloy imparts advantages to the protective layer.

Problems associated with electroless Co are nodular growth from the deposited alloy and unintended deposition onto surfaces other than the primary surfaces to be coated. Nodular, dendritic growth (5 to 30 nanometers) of the electroless deposit at the barrier/Cu interface can form bridges between interconnects/capping layers, can increase current leakage, and in extreme cases can even result in electrical shorts. Unintended deposition of small, isolated alloy particles on the surface of the dielectric similarly may result in current leakage and even electrical shorts.

Electroless Co has also been discussed as a barrier layer under metal interconnects to form a barrier between the interconnects and the dielectrics in which they are formed.

Therefore, there is a particular need for an electroless deposition method and plating solution which can result in an electroless layer substantially free of nodular growth, and a substantially particle-free dielectric.

### SUMMARY OF THE INVENTION

Among the various aspects of the invention are to provide a method and compositions for Co electroless plating which yields a level deposit; and to provide a method and compositions for Co electroless plating which is suitable for use in capping applications in microelectronic devices; etc.

Briefly, therefore, the invention is directed to a composition for metal plating which comprises a source of Co ions, a reducing agent, and a stabilizer selected from among various oxime-based compounds.

The invention is also directed to a method for electrolessly depositing Co or Co alloys onto a metal-based substrate in manufacture of microelectronic devices. The method comprises contacting the metal-based substrate with an electroless deposition composition comprising an oxime-based compound stabilizer and a source of Co ions.

Other objects and features of the invention will be in part apparent and in part pointed out hereinafter.

### BRIEF DESCRIPTION OF THE FIGURES

FIGS. 1A and 1B are SEM photographs of a Co alloy diffusion protection layer not of the invention. FIG. 1A is magnified 80,000×. FIG. 1B is magnified 40,000×.

FIGS. 2A and 2B are SEM photographs of a Co alloy diffusion protection layer of the invention. FIG. 2A is magnified 80,000×. FIG. 2B is magnified 40,000×.

### DETAILED DESCRIPTION OF PREFERRED EMBODIMENTS

In accordance with the invention, Co and Co alloys are deposited using methods and compositions which yield a deposit substantially free of nodular growth and isolated alloy particles on the dielectric. For example, a smooth electroless cap can be electrolessly deposited over an interconnect feature in a microelectronic device. The invention is described here in the context of a Co-based cap, but is also applicable to other electroless Co applications in the microelectronics industry.

The electroless deposition method and composition of the invention have been shown to achieve a deposit having a surface roughness on the order of about 10 angstroms or less for a deposited layer having thickness between about 50 and about 200 angstroms.

The present invention stems from the discovery that certain oxime-based compounds such as certain ketoximes or aldoximes, for example, dimethylglyoxime, act as stabilizers in Co-based electroless plating baths. Exemplary oxime-based compound stabilizers for use in the plating baths of the present invention include ketoximes and aldoximes. Ketoximes are commonly formed by a condensation reaction between ketones and hydroxylamine or hydroxylamine derivatives. Exemplary ketoximes include dimethylglyoxime and 1,2-cyclohexanedione dioxime. Aldoximes are commonly formed by a condensation reaction between aldehydes and hydroxylamine or hydroxylamine derivatives. Exemplary aldoximes include salicylaldoxime and syn-2-pyridinealdoxime. In the context of this description, “oxime-based” refers to compounds which comprise the functional group of the type formed by a condensation reaction between hydroxylamine or a hydroxylamine derivative and a carbonyl group, which carbonyl group may be either a ketone or an aldehyde; including such compounds whether formed by this condensation reaction or by some other mechanism, as it is the functional group, not the reaction mechanism, which is important. The structures of some oxime-based compound stabilizers are shown in Table I.

TABLE I
Oxime-Based Compounds for Use as Stabilizers

| Name | Structure |
|---|---|
| Dimethylglyoxime | 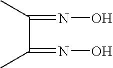 |
| Salicylaldoxime | 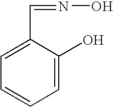 |
| 1,2-Cyclohexanedione dioxime | 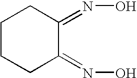 |
| syn-2-Pyridinealdoxime | 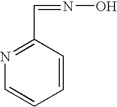 |

Advantageously, when oxime-based compounds are added to Co-based electroless plating baths, the stabilizers reduce stray deposition of Co or Co alloys onto the dielectric and reduce the formation of Co-based nodules in the deposited cap. Without being bound to a particular theory, it is preliminarily believed that the stabilizing capacity of these compounds may be related to their chelating strength, in that oximes chelate metal ions in solution more strongly than the primary chelator, which may be, for example, citric acid. For example, depending upon solution conditions, the log of the stability constant, k, of Cu with dimethylglyoxime may be between about 9 and about 11. The log k of Ni with dimethylglyoxime may be between about 12 and about 17. Conversely, the log k of Cu with citric may be between about 4 and about 6, and the the log k of Ni with citric may be between about 4 and about 6. Co, on the other hand, is still chelated by the primary chelator, citric acid. Dimethylglyoxime preferentially chelates metal impurities such as Ni, Cu, and others and shifts their reduction potentials, thus avoiding the tendency of localized nucleation and particle formation. Excess amounts of dimethylglyoxime may further chelate with Co and affect the initiation and growth rate of Co deposition. However, because of the strong chelating effect, the plating bath is completely deactivated when the concentration level reaches 200 ppm or higher.

In the baths of the invention, the concentration of the oxime-based compound stabilizer is between about 2 ppm to about 150 ppm. Hereinafter, the term “ppm” shall refer to the concentration of an additive in mass units of additive per mass units of plating solution. For example, 5 ppm shall mean 5 mg of the additive per kilogram of plating solution. Because the density of the solution is approximately 1 kg/L, a 5 ppm concentration is approximately 5 mg per Liter of plating solution. Under such conditions, the oxime-based compound acts as a bath stabilizer and a leveler of the deposit.

Therefore, according to the plating baths of the present invention, oxime-based compounds are added to the bath in a concentration range of about 2 ppm to about 150 ppm, preferably from about 5 ppm to about 50 ppm, even more preferably about 5 ppm to about 20 ppm.

Electroless plating baths for electroless plating of Co or Co alloys such as in a metal capping layer onto a metal-filled interconnect generally comprise a source of deposition ions, a reducing agent, a complexing and/or chelating agent, and a surfactant. The bath is buffered within a certain pH range. Optionally, the bath may also comprise a source of refractory ions.

For the deposition of a Co-based alloy, the bath comprises a source of Co ions. In the context of capping of electrical interconnects, they provide several advantages. They do not significantly alter the electrical conductivity characteristics of Cu. Cobalt provides good barrier and electromigration protection for Cu. Cobalt, which is selected in significant part because it is immiscible with Cu, does not tend to alloy with Cu during assembly or over time during service. The Co ions are introduced into the solution as an inorganic Co salt such as the hydroxide, chloride, sulfate, or other suitable inorganic salt, or a Co complex with an organic carboxylic acid such as Co acetate, citrate, lactate, succinate, propionate, hydroxyacetate, or others. Co(OH)₂ may be used where it is desirable to avoid overconcentrating the solution with Cl⁻ or other anions. In one embodiment, the Co salt or complex is added to provide about 1 g/L to about 20 g/L of Co²⁺ to yield a Co-based alloy of high Co metal content. In some applications, the Co content in the electroless bath is very low, for example, as low as between about 0.1 g/L and about 1.0 g/L of Co²⁺.

Depending upon the deposition mechanism and the desired alloy, the reducing agent is chosen from either a phosphorus-based reducing agent or a boron-based reducing agent. The reducing agent is discussed more fully below.

The bath further contains buffering agents. The bath typically contains a pH buffer to stabilize the pH in the desired range. In one embodiment, the desired pH range is between about 7.5 and about 10.0. In one embodiment, it is between 8.2 up to around 10, for example between 8.7 and 9.3. These pH ranges provide a mildly alkaline electroless bath, as opposed to the highly alkaline baths that are conventionally known. Exemplary buffers include, for example, borates, tetra- and pentaborates, phosphates, acetates, glycolates, lactates, ammonia, and pyrophosphate. The pH buffer level is on the order of between about 4 g/L and about 50 g/L.

A complexing and/or chelating agent is included in the bath to keep Co ions in solution. Because the bath is typically operated at a mildly alkaline pH of between about 7.5 and about 10.0, Co²⁺ ions have a tendency to form hydroxide salts and precipitate out of solution. The complexing agents used in the bath are selected from among citric acid, malic acid, glycine, propionic, succinic, lactic acids, DEA, TEA, and ammonium salts such as ammonium chloride, ammonium sulfate, ammonium hydroxide, pyrophosphate, and mixtures thereof. Some complexing agents, such as cyanide, are avoided because they complex with Co ions too strongly and inhibit deposition and/or present environmental issues. The complexing agent concentration is selected such that the molar ratio between the complexing agent and Co is between about 2:1 and about 10:1, generally. Depending on the complexing agent molecular weight, the level of complexing agent may be on the order of between about 10 g/L and about 120 g/L.

Surfactants may be added to promote wetting of the metal interconnect surface and enhance the deposition of the capping layer. The surfactant seems to serve as a mild deposition inhibitor which can suppress three-dimensional growth to an extent, thereby improving morphology and topography of the film. It can also help refine the grain size, which yields a more uniform coating which has grain boundaries which are less porous to migration of Cu. Cationic surfactants which are film formers are avoided in the composition of the invention. Exemplary anionic surfactants include alkyl phosphonates, alkyl ether phosphates, alkyl sulfates, alkyl ether sulfates, alkyl sulfonates, alkyl ether sulfonates, carboxylic acid ethers, carboxylic acid esters, alkyl aryl sulfonates, and sulfosuccinates. Exemplary non-ionic surfactants include glycol and glycerol esters, polyethylene glycols, and polypropylene glycol/polyethylene glycol. The level of surfactant is on the order of between about 0.01 g/L and about 5 g/L.

If desired, the plating bath may also include a refractory metal ion, such as W, Mo, or Re, which functions to increase thermal stability, corrosion resistance, and diffusion resistance. Exemplary sources of W ions are tungstic acids, phosphotungstate, tungsten oxides, and mixtures thereof. For example, one preferred deposition bath contains between about 0.1 g/L and about 10 g/L of tungstic acid. Other sources of refractory metal include ammonium molybdate or molybdenum oxides.

Other additives, as are conventionally known in the art such as levelers, accelerators, and grain refiners may also be added. At low concentrations, hydrazine may be added as a leveler, as disclosed in U.S. patent application Ser. No. 11/085,304. Levelers act in synergy with the oxime compound stabilizer of the invention to further enhance deposition morphology and topography, and also to control the deposition rate.

In some applications, the bath must be substantially alkali metal ion free.

Plating typically occurs at a bath temperature of between about 50° C. to about 90° C. If the plating temperature is too low, the reduction rate is too low, and at a low enough temperature, Co reduction does not initiate at all. At too high a temperature, the plating rate increases, and the bath becomes too active. For example, Co reduction becomes less selective, and Co plating may occur not just on the Cu interconnect features of a wafer substrate, but also on the dielectric material. Further, at very high temperatures, Co reduction occurs spontaneously within the bath solution and on the sidewalls of the plating tank.

The deposition mechanism and the desired alloy dictate the choice of the reducing agent. If an alloy is desired which contains phosphorus, hypophosphite is chosen. If an alloy is desired which contains boron, a boron-based reducing agent is chosen, such as a borane. Additionally, both phosphorous and a boron-based reducing agents may be added to the plating bath.

Among the phosphorus-based reducing agents, hypophosphite is a preferred reducing agent in electroless plating films because of its low cost and docile behavior as compared to other reducing agents. When hypophosphite is chosen as the reducing agent, the finished alloy contains elemental phosphorus. As is known, the plating solution requires an excess of H₂PO₂⁻ to reduce Co²⁺ into the Co alloy. As noted in Mallory and Hajdu, pp. 62-68, the molar ratio of Co ions to hypophosphite ions in the plating solution is between 0.25 to 0.60, preferably between 0.30 and 0.45, for example. To ensure that a sufficient concentration of hypophosphite is present in the plating bath for rapid initiation of plating and improved plating morphology, the hypophosphite salt is added in an initial concentration of about 2 g/L to about 30 g/L, for example about 21 g/L.

Hypophosphite reduces the metal ion spontaneously only upon a limited number of substrates, including Co, Ni, Pd, and Pt. Not included in this list is Cu, which is a particular metal of interest for its use in filling interconnect features such as vias and trenches in microelectronic devices. For hypophosphite reduction over a Cu substrate, the Cu surface must first be activated, for example, by seeding with the metal to be deposited (i.e., Co) or by a catalyst such as Pd, or by treating the surface with a strong reducing agent such as DMAB.

Other preferred reducing agents include the boron-based reducing agents, such as borohydride, dimethyl amine borane (DMAB), diethyl amine borane (DEAB), pyridine borane, and morpholine borane. When a boron-based reducing agent is chosen, elemental boron becomes part of the plated alloy. As is known, the plating solution requires approximately equal molar amounts of the boron-based reducing agent to reduce Co²⁺ into the Co alloy. To ensure that a sufficient concentration of reducing agent is present in the plating bath, dimethyl amine borane, for example, is added in an initial concentration of about 0.5 g/L to about 30 g/L, for example about 10 g/L.

Unlike hypophosphite, plating solutions with boron-based reducing agents do not need a copper surface activation step. Instead, the reducing agent autocatalyzes reduction of the metal ion onto the Cu surface.

Because of the presence of reducing agents, elemental P or B can co-deposit to some extent with the Co. An effect of these elements in the deposit is to reduce grain size, inhibit crystalline structure formation, and enhance its amorphous nature, which can render the microstructure more impervious to Cu electromigration. For example, Co—W—B with high W content has an amorphous phase. Without being bound to a particular theory, it is believed that the presence of refractory metal together with B and P improves the barrier properties by filling in the grain boundaries of the crystalline structure of the deposit.

Employing the foregoing baths, a variety of alloys can be deposited; for example diffusion barrier layers include Co—W—P, Co—W—B, Co—W—B—P, Co—B—P, Co—B, Co—Mo—B, Co—W—Mo—B, Co—W—Mo—B—P, and Co—Mo—P.

According to the practice of electroless deposition, a layer of Co or Co alloy may be deposited by exposure of the electroless plating compositions to, for example, a patterned silicon substrate having vias and trenches, in which a metal layer, such as Cu, has already filled into the vias or trenches. This exposure may comprise dip, flood immersion, spray, or other manner of exposing the substrate to a deposition bath, with the provision that the manner of exposure adequately achieves the objectives of depositing a metal layer of the desired thickness and integrity.

The electroless plating compositions according to the present invention may be used in conventional continuous mode deposition processes. In the continuous mode, the same bath volume is used to treat a large number of substrates. In this mode, reactants must be periodically replenished, and reaction products accumulate, necessitating periodic filtering of the plating bath. Alternatively, the electroless plating compositions according to the present invention are suited for so-called “use-and-dispose” deposition processes. In the use-and-dispose mode, the plating composition is used to treat a substrate, and then the bath volume is directed to a waste stream. Although this latter method may be more expensive, the use and dispose mode requires no metrology, that is, measuring and adjusting the solution composition to maintain bath stability is not required.

For auto-catalyzation of the electroless deposition, boron-based reducing agents may be employed such as an alkylamine borane reducing agent, for example DMAB, DEAB, morpholine borane, mixtures thereof, or mixtures thereof with hypophosphite. Oxidation/reduction reactions involving the boron-based reducing agents and Co or Co alloy deposition ions are catalyzed by Cu. In particular, at certain plating conditions, e.g., pH & temperature, the reducing agents are oxidized in the presence of Cu, thereby reducing the deposition ions to metal which deposits on the Cu. The process is substantially self-aligning in that the metal is deposited essentially only on the Cu interconnect. However, conventional electroless plating baths deposit a Co alloy that amplifies the roughness of the underlying Cu interconnect. In many instances, stray Co is deposited onto the dielectric. If dimethylglyoxime is added to the plating solution, as in the present invention, the electroless plating bath deposits a smooth and level Co or Co alloy capping layer without stray deposition onto the dielectric.

As an alternative, certain embodiments of the invention employ an electroless deposition process which does not employ a reducing agent which renders Cu catalytic to metal deposition. For such processes a surface activation operation is employed to facilitate subsequent electroless deposition. A currently preferred surface activation process utilizes a Pd immersion reaction. Other known catalysts are suitable and include Ru and Pt. Alternatively, the surface may be prepared for electroless deposition by seeding as with, for example, Co seeding deposited by electrolytic deposition, PVD, CVD, or other technique as is known in the art.

The following examples further illustrate the invention.

### EXAMPLE 1

A first electroless plating bath was prepared comprising the following components:

3 to 7 g/L of CoCl₂.6H₂O

10 to 40 g/L C₆H₈O₇ (citric acid)

0 to 10 g/L of H₃BO₃ (boric acid)

3 to 10 g/L of H₃PO₂ (hypophosphorous acid)

0.2 to 0.6 g/L H₂WO₄ (tungstic acid)

250 mg/L Calfax 10LA-75 (Pilot Chemical Co.)

5 to 20 mg/L of dimethylglyoxime

TMAH for pH adjustment

2 Liters of this bath were prepared at room temperature by preparing two solutions, Part A and Part B. The components were added according to the following protocol:

A. Prepare Part A

1. to 14 g CoCl₂.6H₂O dissolved in water.
2. Added 20 to 40 grams of citric acid and 0 to 20 grams of boric acid to the Co²⁺ solution.
3. pH adjusted to about 7.0 using TMAH.
4. Pre-dissolved 0.2-0.6 grams of tungstic acid in TMAH and added to the solution.
5. Added 250 mg Calfax.
6. pH adjusted to about 9.0 using TMAH.
7. 10 to 40 mg of dimethylglyoxime added.
8. pH readjusted to about 9.0 using TMAH and dilute with water to 1 L.
9. Filter (0.22 micron) to remove undissolved solids.
   B. Prepare Part B
1. 6 to 20 grams of hypophosphorous acid dissolved in water.
2. pH adjusted to about 9.0 using TMAH and dilute with water to 1 L.
3. Filtered to remove any solids.
   C. Prepare Electroless Plating Bath by Combining Approximately Equal Volumes of Parts A and B.

For comparison, a second electroless plating bath was prepared according to the same sequences of steps, having the same components except for the dimethylglyoxime stabilizer. The bath had the following components:

3 to 7 g/L of CoCl₂.6H₂O

10 to 40 g/L C₆H₈O₇ (citric acid)

0 to 10 g/L of H₃BO₃ (boric acid)

3 to 10 g/L of H₃PO₂ (hypophosphorous acid)

0.2 to 0.6 g/L H₂WO₄ (tungstic acid)

250 mg/mL Calfax 10LA-75

TMAH for pH adjustment

Balance of DI water to 1 L

This bath was prepared at room temperature, and adjusted to pH of about 9.0 with TMAH. Plating occurred at a temperature between about 55° C. and about 80° C.

### EXAMPLE 2

Another exemplary bath was prepared having the following components:

3 to 7 g/L of CoCl₂.6H₂O

10 to 30 g/L C₆H₈O₇ (citric acid)

0 to 6 g/L of H₃BO₃ (boric acid)

0.2 to 0.6 g/L H₂WO₄ (tungstic acid)

4 to 8 g/L of H₃PO₂ (hypophosphorous acid)

0.2 to 5 g/L (CH₃)₂NHBH₃ (DMAB)

5 to 20 mg/L of dimethylglyoxime

250 mg/mL Calfax 10LA-75

TMAH for pH adjustment

Balance of DI water to 1 L

This bath was prepared at room temperature, and adjusted to pH between about 8.0 and about 9.5 with TMAH. Plating occurred between about 55° C. and about 80° C.

### EXAMPLE 3

A further bath was prepared having the following components:

20 to 40 g/L of CoCl₂.6H₂O

40 to 120 g/L C₆H₈O₇ (citric acid)

0 to 60 g/L of H₃BO₃ (boric acid)

2 to 10 g/L H₂WO₄ (tungstic acid)

5 to 30 g/L of H₃PO₂ (hypophosphorous acid)

0 to 10 g/L (CH₃)₂NHBH₃ (DMAB)

5 to 100 mg/L of dimethylglyoxime

TMAH for pH adjustment

Balance of DI water to 1 L

This bath was prepared at room temperature, and adjusted to pH between about 8.0 and about 9.5 with TMAH. Plating occurred between about 55° C. and about 80° C.

### EXAMPLE 4

Ternary alloys consisting of Co—W—P were electrolessly deposited from the electroless plating baths of Example 1. The starting substrate was made of silicon. The substrate had exposed patterned Cu wires embedded in Ta/TaN stack barrier surrounded with interlevel dielectric (ILD) made of SiO₂-based material. The Cu wires had a width on the order of 120 nm, and after CMP, the Cu surface was lower than the surrounding dielectric. The surface roughness was about 6 Angstroms.

The patterned Cu substrate was exposed to a preclean solution of 1% sulfuric acid to remove post-CMP inhibitor residues, copper(II) oxide layer, and post-CMP slurry particles from ILD. It was then rinsed in deionized (DI) water, and subsequently activated with Pd.

To plate the alloy, the substrate was immersed in the Co—W—P electroless deposition solution of Example 1. The baths were kept at 75° C. to 85° C., at a pH of about 9.0, and plating occurred for 1 minute.

Under experimental conditions, this bath plated a 180 Angstrom thick Co—W—P alloy layer onto the copper substrate with a surface roughness of about 8 Angstroms. Thus, there was minimal increase in the surface roughness of the Co—W—P alloy layer plated with the baths of the present invention compared to the underlying copper substrate surface roughness. Additionally, the layer was substantially free of nodular growth at the layer edges.

For comparison, the substrate was immersed in the comparative, dimethylglyoxime stabilizer-free Co—W—P electroless deposition solution of Example 1.

### EXAMPLE 5

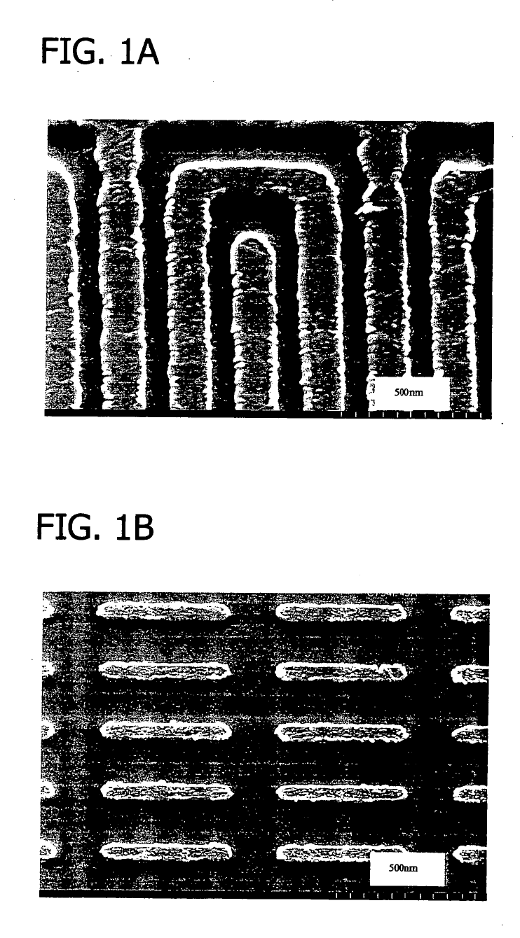

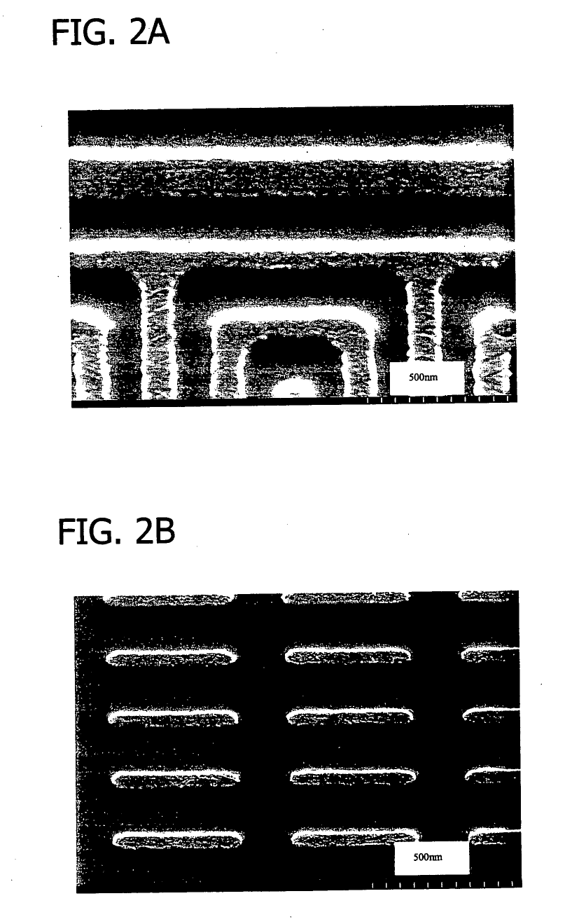

Scanning electron microscope (SEM) photographs were taken of Co—W—P capping layers and are illustrated in FIGS. 1 and 2. The lack of nodular growth as well as the reduction of isolated alloy deposits on the dielectric achieved in a Co—W—P layer deposited from an electroless plating bath comprising 10 ppm of dimethylglyoxime stabilizer in accordance with the invention as compared to a plating bath without dimethylglyoxime stabilizer can be seen by referring to FIGS. 1 and 2. The smooth surface of FIGS. 2A and 2B exhibit the Co—W—P layer deposited in accordance with the present invention, i.e., a bath containing dimethylglyoxime. FIGS. 1A and 1B exhibit the Co—W—P layer deposited by a plating bath that does not contain any dimethylglyoxime stabilizer.

A Co—W—P capping layer that exhibits the surface smoothness and planarity of the layer shown in FIGS. 2A and 2B is smooth enough as deposited to function as a diffusion barrier layer over a Cu interconnect feature, with substantially reduced risk of electrical short either immediately after deposition or during the service life of the interconnect feature.

The Co—W—P capping layer of FIG. 1A and 1B has a greater risk of nodule growth, which can cause an electrical short.

In view of the above, it will be seen that the several objects of the invention are achieved and other advantageous results attained.

When introducing elements of the present invention or the preferred embodiment(s) thereof, the articles “a”, “an”, “the” and “said” are intended to mean that there are one or more of the elements. For example, that the foregoing description and following claims refer to “an” interconnect means that there are one or more such interconnects. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

What is claimed is:

1. A method for electrolessly depositing Co or Co alloys onto a substrate in manufacture of microelectronic devices, the method comprising:
contacting the substrate with an electroless deposition composition comprising an oxime-based compound stabilizer and a source of Co ions.

2. The method of claim 1 wherein the electroless deposition composition has a pH between about 7.5 and about 10.

3. The method of claim 1 wherein the oxime-based compound stabilizer is an aldoxime.

4. The method of claim 3 wherein the oxime-based compound is selected from the group consisting of salicylaldoxime, syn-2-pyridinealdoxime, and a combination thereof.

5. The method of claim 1 wherein the oxime-based compound stabilizer is a ketoxime.

6. The method of claim 5 wherein the oxime-based compound is selected from the group consisting of dimethylglyoxime, 1,2-cyclohexanedione dioxime, and a combination thereof.

7. The method of claim 1 wherein the oxime-based compound stabilizer is present in the electroless deposition composition at a concentration from about 2 ppm to about 150 ppm.

8. The method of claim 1 wherein the oxime-based compound stabilizer is present in the electroless deposition composition at a concentration from about 5 ppm to about 50 ppm.

9. The method of claim 1 wherein the oxime-based compound stabilizer is present in the electroless deposition composition at a concentration from about 5 ppm to about 20 ppm.

10. The method of claim 1 wherein the electroless deposition composition further comprises a reducing agent.

11. An electroless plating solution for plating a metal capping layer onto a metal-filled interconnect in a microelectronic device, the solution comprising:
a source of Co ions;
a reducing agent; and
an oxime-based compound stabilizer.

12. The electroless plating solution of claim 11 wherein the solution has a pH from about 7.5 to about 10.

13. The electroless plating solution of claim 11 wherein the oxime-based compound stabilizer is an aldoxime.

14. The electroless plating solution of claim 13 wherein the oxime-based compound is selected from the group consisting of salicylaldoxime, syn-2-pyridinealdoxime, and a combination thereof.

15. The electroless plating solution of claim 11 wherein the oxime-based compound stabilizer is a ketoxime.

16. The electroless plating solution of claim 15 wherein the oxime-based compound is selected from the group consisting of dimethylglyoxime, 1,2-cyclohexanedione dioxime, and a combination thereof.

17. The electroless plating solution of claim 11 wherein the oxime-based compound stabilizer is present at a concentration from about 2 ppm to about 150 ppm.

18. The electroless plating solution of claim 11 wherein the oxime-based compound stabilizer is present at a concentration from about 5 ppm to about 50 ppm.

19. The electroless plating solution of claim 11 wherein the oxime-based compound stabilizer is present at a concentration from about 5 ppm to about 20 ppm.

20. The electroless plating solution of claim 11 wherein the source of Co ions is present such that a concentration of Co ions is between about 1 g/L and about 20 g/L.

21. The electroless plating solution of claim 11 wherein the source of Co ions is present such that a concentration of Co ions is between about 0.1 g/L and about 1.0 g/L.

22. The electroless plating solution of claim 11 wherein the reducing agent is a source of hypophosphite.

23. The electroless plating solution of claim 11 wherein the reducing agent is a boron-based reducing agent.

24. The electroless plating solution of claim 11 further comprising:
a source of refractory metal ions;
an organic complexing agent; and
a surfactant.

25. An electroless plating solution for plating a metal capping layer onto a metal-filled interconnect in a microelectronic device, the solution comprising:
a source of Co ions present such that a concentration of the Co ions is between about 1 g/L and about 20 g/L;
a source of hypophosphite at a concentration between about 2 g/L and about 30 g/L;
an oxime-based compound stabilizer at a concentration between about 2 ppm and about 150 ppm;
a source of refractory metal ions;
an organic completing agent; and
a surfactant;
wherein the solution is slightly alkaline.

26. The electroless plating solution of claim 25 wherein the solution is substantially free of alkali metal ions.
